(19) United States
(12) Patent Application Publication
(10) Pub. No.: US 2026/0055960 A1
(43) Pub. Date: Feb. 26, 2026

(54) DRYING APPARATUS AND ASSOCIATED DRYING PROCESS

(71) Applicant: ASPCOLD LIMITED, Yeadon, Leeds (GB)

(72) Inventor: Roger Valentine Stow, Cononley (GB)

(21) Appl. No.: 19/105,488

(22) PCT Filed: Aug. 23, 2023
(86) PCT No.: PCT/GB2023/052198

§ 371 Date: Feb. 21, 2025

(30) Foreign Application Priority Data
Aug. 23, 2022 (GB) 2212257.6

(51) Int. Cl. F26B 1/00; C02F 11/12; F26B 17/08; F26B 23/00

(52) U.S. Cl. CPC F26B 1/00; C02F 11/12; F26B 17/08; F26B 23/001; F26B 2200/18

(57) ABSTRACT

The present invention provides a drying apparatus. The apparatus includes a first, upper chamber comprising a freezing section; and a second, lower chamber comprising a thawing section and a drying section. The first, upper chamber further includes an inlet and first conveying means arranged to convey material through and within the freezing section. The second lower chamber includes second conveying means arranged to convey material through and within the thawing section, and third conveying means arranged to convey material through and within the drying section. A first outlet is provided in the drying section through which dried material exits the apparatus. Generally, the material provided to be dried by the drying apparatus is alum sludge.

The invention to which this application relates is a drying apparatus and an associated drying process.

Although the following description refers exclusively to the drying out of Alum sludge for subsequent re-use, the person skilled in the art will appreciate that the present invention could also be used on other industrial waste products permitted subsequent re-use thereof.

Alum sludge is produced as a by-product from fresh water works, such as water treatment and water purification plants. Aluminium sulphate and/or other aluminium salts, and polymers are introduced into the raw water stream as a flocculant and coagulant to enable debris in the water to be attracted together and sink to form clear water. The settled debris is named alum sludge. This sludge is continuously removed from the settling lagoons and the free water in the sludge is removed mechanically by centrifuge or press resulting in a sludge cake of around 80% moisture content. This alum sludge cake is classified as a waste material. Around 500,000 tons of this alum sludge cake is produced annually in the UK and mostly taken to landfill. There is therefore a clear need to provide means by which this remaining alum sludge can be processed further, enabling its reuse and avoiding the need to simply transport it to landfill.

It is therefore an aim of the present invention to provide an apparatus for drying alum sludge for subsequent reuse, which overcomes the aforementioned problems associated with the prior art.

It is a further aim of the present invention to provide a process for drying alum sludge for subsequent reuse, which overcomes the aforementioned problems associated with the prior art.

According to a first aspect of the invention there is provided a drying apparatus, said apparatus including:
a first, upper chamber comprising a freezing section;
a second, lower chamber comprising a thawing section and a drying section;
the first, upper chamber further including an inlet, and first conveying means arranged to convey material through and within the freezing section;
the second lower chamber further including second conveying means arranged to convey material through and within the thawing section, and third conveying means arranged to convey material through and within the drying section; and
a first outlet in the drying section through which dried material exits the apparatus.

In a preferred embodiment, said apparatus is an alum sludge drying apparatus. Typically, said material is alum sludge.

Typically, the first, second and third conveying means each extend substantially along a length of the interior of the respective chambers.

In one embodiment, the second conveying means is disposed below the first conveying means. Typically, at least one aperture is provided located in the wall/interface between the first and second chambers, permitting material to be deposited from the first conveying means on to the second conveying means.

Typically, said first conveying means comprises one or more conveyor belt members. In embodiments where two or more conveyor belt members are provided, said belt members are disposed vertically spaced apart from one another.

In one embodiment, first and at least second conveyor belt members are provided forming the first conveying means, the second conveyor belt member disposed spaced apart from and vertically below the first conveyor belt member. Preferably, the first and at least second conveyor belt members are arranged to convey material in opposing directions, in use.

In one embodiment, a first conveyor belt member is arranged to convey material from a first end to a second, opposing end thereof, and deposit said material on to a first end of a second conveyor belt member, disposed vertically below the first conveyor belt member. Typically, the first end of the second conveyor belt member extends beyond the second end of the first conveyor belt member. Such an arrangement permits the material, as it is moved to the end of the first conveyor belt member, to cascade therefrom and down on to the second conveyor belt member, in use.

Typically, the first conveying means is arranged to move at a speed of between 5 m/hour and 20 m/hour.

Typically, said second conveying means comprises one or more conveyor belt members. In embodiments where two or more conveyor belt members are provided, said belt members are disposed vertically spaced apart from one another.

In one embodiment, first and at least second conveyor belt members may be provided forming the second conveying means, the second conveyor belt member being disposed spaced apart from and vertically below the first conveyor belt member.

Preferably, the first and at least second conveyor belt members are arranged to convey material in opposing directions, in use.

In one embodiment, a first conveyor belt member of the second conveying means may be arranged to convey material from a first end to a second, opposing end thereof, and deposit said material on to a first end of a second conveyor belt member, disposed vertically below the first conveyor belt member. Typically, the first end of the second conveyor belt member extends beyond the second end of the first conveyor belt member.

Typically, the second conveying means is arranged to move at a speed of between 5 m/hour and 15 m/hour.

In one embodiment, the third conveying means is disposed below the second conveying means, within the second, lower chamber.

Typically, said third conveying means comprises one or more conveyor belt members. In embodiments where two or more conveyor belt members are provided, said belt members are disposed vertically spaced apart from one another. Preferably, a plurality of conveyor belt members is provided associated with the third conveying means.

In one embodiment, first and at least second conveyor belt members may be provided forming the third conveying means, the second conveyor belt member being disposed spaced apart from and vertically below the first conveyor belt member. Preferably, the first and at least second conveyor belt members are arranged to convey material in opposing directions, in use. Where a plurality of conveyor belt members is provided, third and further conveyor belt members are provided in a similar such arrangement.

In one embodiment, a first conveyor belt member of the third conveying means may be arranged to convey material from a first end to a second, opposing end thereof, and deposit said material on to a first end of a second conveyor belt member, disposed vertically below the first conveyor belt member. Typically, the first end of the second conveyor belt member extends beyond the second end of the first conveyor belt member. A similar such arrangement continues in embodiments wherein third and further conveyor belt members are provided associated with the third conveying means.

Typically, the third conveying means is arranged to move at a speed of between 2 m/hour and 20 m/hour.

In a preferred embodiment, said second conveying means is provided to be tilted/inclined at an angle perpendicular to the length or path of movement thereof. Typically, said angle is between 1°-5° with respect to the horizontal plane of the conveying means. By providing the second conveying means, associated with the thawing section of the apparatus, at such an angle, this permits liquid or supernatant thawing from the material to run-off the side of the conveying means and away from the material.

In embodiments where the second conveying means comprises two or more conveyor belt members, each of said conveyor belt members is provided to be tilted/inclined at an angle perpendicular to the length or path of movement thereof. Typically, each of said conveyor belt members of the second conveying means is arranged to be tilted/inclined in the same direction.

In one embodiment, liquid collection means are provided associated with the second conveying means, along the length thereof. Typically, said liquid collection means are provided located at and along the lower side of the inclined second conveying means, arranged to collect liquid or supernatant thawing and running/draining from the material. Typically, liquid removal means are provided to remove the collected liquid/supernatant from the apparatus.

In embodiments where the second conveying means comprises two or more conveyor belt members, said liquid collection means are provided to be located at and along the lower side of each of the inclined belt members.

In one embodiment, said first conveying means further includes side walls provided associated therewith, along the length thereof. Typically, said side walls are provided to maintain the material on the first conveying means as it is moved through the freezing section, in use.

Typically, refrigeration means are provided to cool the temperature of the first, upper chamber and thus the freezing section.

In one embodiment, the first, upper chamber is maintained at a temperature between −5° C. to −20° C.

In some embodiments, the first, upper chamber is provided to be insulated to help maintain the temperature at a desired level.

Typically, the material is arranged to be deposited on to the first conveying means at an average thickness of between 10 mm to 40 mm.

In one embodiment, the second, lower chamber is maintained at a temperature above the ambient temperature where the apparatus is located. Typically, the second, lower chamber is maintained at a temperature of between 10° C. to 30° C. above the ambient temperature. Preferably, the chamber is maintained at a temperature of about 20° C. above the ambient temperature.

In one embodiment, one or more evaporator means are located with the first, upper chamber. Typically, said one or more evaporator means are provided to cool the internal temperature of the first, upper chamber to the required temperature. Preferably, said one or more evaporator means are provided in the form of one or more forced air and/or air-cooling evaporators. Typically, a plurality of evaporator means is provided located along the length of the first, upper chamber.

Typically, the apparatus further includes condenser means provided therewith, in communication with the evaporator means. Preferably, said condenser means are provided in the form of one or more refrigeration condensers.

In preferred embodiments, one or more refrigeration condensers are provided in fluid communication with one or more forced air and/or air-cooling evaporators located with the first, upper chamber.

In one embodiment, the evaporator means are provided to impart a flow of cooled air in the first, upper chamber. Typically, the speed of said flow of air is provided to be between 1 m/s and 10 m/s.

In one embodiment, heat expelled from said condenser means is arranged to be directed into the second, lower chamber, heating the same to the desired temperature. Thus, as the condenser means and evaporator means work together to cool the first, upper chamber, the heat drawn and subsequently expelled from the condenser means is directed into the second, lower chamber by means of the heat pump effect; the first, upper chamber acting as a heat source and the second, lower chamber acting as a heat sink.

Typically, the second conveying means is arranged to maintain the material in the thawing section for a period of between 30 minutes to 3 hours. Preferably, the second conveying means is arranged to maintain the material in the thawing section for a period of about 1 hour.

Typically, the third conveying means is arranged to maintain the material in the drying section for a period of between 10 to 18 hours. Preferably, the second conveying means is arranged to maintain the material in the drying section for a period of about 14 hours.

Typically, the apparatus is arranged to provide continuous movement of material therein from the freezing section through to the drying section and subsequently exiting through the outlet.

In one embodiment, the apparatus further includes containing means in which material to be dried and processed may be located and stored. Typically, further conveying means are provided to move the material from the containing means to the inlet. Preferably, said further conveying means are provided in the form of a screw conveyor member or auger conveyor member.

Preferably, the inlet includes depositing means arranged to distribute material evenly across the surface of the first conveying means at a first end thereof.

Preferably, the moisture content of the material upon exiting the apparatus is no more than about 55%. Generally, alum sludge waste will have a moisture content of around 97%, and after processing into an alum sludge “cake”, the moisture content is generally around 80%, and the material is unusable resulting in it being sent to landfill. By reducing the moisture content to levels of 55% and below, the dried alum sludge can be readily recycled and reused, either as a building material, or after further processing by mixing and heating with a caustic soda solution, to produce aluminium oxide.

The freezing process as the material moves through the freezing section of the apparatus grows planar ice crystals which, as they grow, push aside the flocs, breaking the chemical bond between the moisture and material. Once the bond has been broken, the material is thawed, allowing clean supernatant to run off and be collected for subsequent use, and the material is then dried and recycled. The present invention therefore has the advantage of providing an efficient means by which to significantly reduce waste created by a material such as alum sludge, by drying it in a manner which removes a significant amount of its moisture content allowing to be reused or repurposed as required. The ultimate costs of the apparatus and the energy consumption is broadly equivalent to that required simply to dispose of the material in a landfill site, with the added benefit that costs may be further recovered by selling on the dried material for reuse.

In another aspect of the present invention, there is provided a process for drying a material using an apparatus as defined above, said process including the steps of:
depositing said material on to first conveying means located in the freezing section of the first, upper chamber through the inlet thereof;
moving said material through the freezing section on said first conveying means at a predetermined rate until the material and moisture within the material has frozen;
depositing the material from the freezing section on to second conveying means located in the thawing section of the second, lower chamber;
moving said material through the thawing section on said second conveying means at a predetermined rate until the material thaws and liquid drains therefrom;
depositing the material from the thawing section on to third conveying means located in the drying section of the second, lower chamber;
moving said material through the drying section on said third conveying means at a predetermined rate until the moisture content of the material is reduced to a desired level; and
removing the dried material from the drying section through an outlet provided therein.

Typically, said material being dried is alum sludge.

Typically, said first conveying means comprises one or more conveyor belt members. Typically, the first conveying means is arranged to move at a speed of between 5 m/hour and 20 m/hour.

Typically, said second conveying means comprises one or more conveyor belt members. Typically, the second conveying means is arranged to move at a speed of between 5 m/hour and 15 m/hour.

Typically, said third conveying means comprises one or more conveyor belt members. Typically, the third conveying means is arranged to move at a speed of between 2 m/hour and 20 m/hour.

Typically, the material is deposited on to the first conveying means at an average thickness of between 10 mm to 40 mm.

In one embodiment, the first, upper chamber is maintained at a temperature between −5° C. to −20° C.

In one embodiment, evaporator means impart a flow of cooled air into the first, upper chamber. Typically, the speed of said flow of air is to be between 1 m/s and 10 m/s.

Typically, the material is maintained in the freezing section and on the first conveying means for a period of between 1 hour and 4 hours. Such a time period is dependent on the machine design capacity, speed of the first conveying means, air temperature of the freezing section in the first, upper chamber and the thickness of the material when deposited on to the first conveying means.

In one embodiment, the second, lower chamber is maintained at a temperature above the ambient temperature where the apparatus is located. Typically, the second, lower chamber is maintained at a temperature of between 10° C. to 30° C. above the ambient temperature. Preferably, the chamber is maintained at a temperature of about 20° C. above the ambient temperature.

In a preferred embodiment, said second conveying means is provided to be tilted/inclined at an angle perpendicular to the length or path of movement thereof. Typically, said angle is between 1°-5° with respect to the horizontal plane of the conveying means.

Thus, in preferred embodiments, as the material is moved through the thawing section on the second conveying means, liquid or supernatant is able to drain from the material down to the lower side of the inclined second conveying means and draining therefrom.

In one embodiment, liquid collection means are provided associated with the second conveying means, along the length of the lower side thereof and collect liquid or supernatant thawing and running/draining from the material. Typically, the collected liquid/supernatant is removed from the apparatus by liquid removal means provided therewith.

Typically, the second conveying means moves at a rate to maintain the material in the thawing section for a period of between 30 minutes to 3 hours. The dwell time of the material in thawing section is dependent on the initial moisture content of the input material.

Typically, the third conveying means moves at a rate to maintain the material in the drying section for a period of between 10 to 18 hours. The dwell time in the drying section is set so that there is some moisture content in the final drier product preventing unwanted dried particles in the air stream.

Typically, the process provides continuous movement of material within the apparatus from the freezing section through to the drying section and subsequently exiting through the outlet.

In one embodiment, material is moved from containing means through further conveying means to the inlet. Preferably, said further conveying means are provided in the form of a screw conveyor member or auger conveyor member.

Preferably, the inlet includes depositing means which distribute material evenly across the surface of the first conveying means at a first end thereof.

Preferably, the moisture content of the material upon exiting the apparatus is no more than about 50%. The moisture content of the final dried material is to prevent unwanted dried particles in the air stream and to make subsequent handling of the product dust free and non-hazardous.

Embodiments of the present invention will now be described with reference to the accompanying figures, wherein:

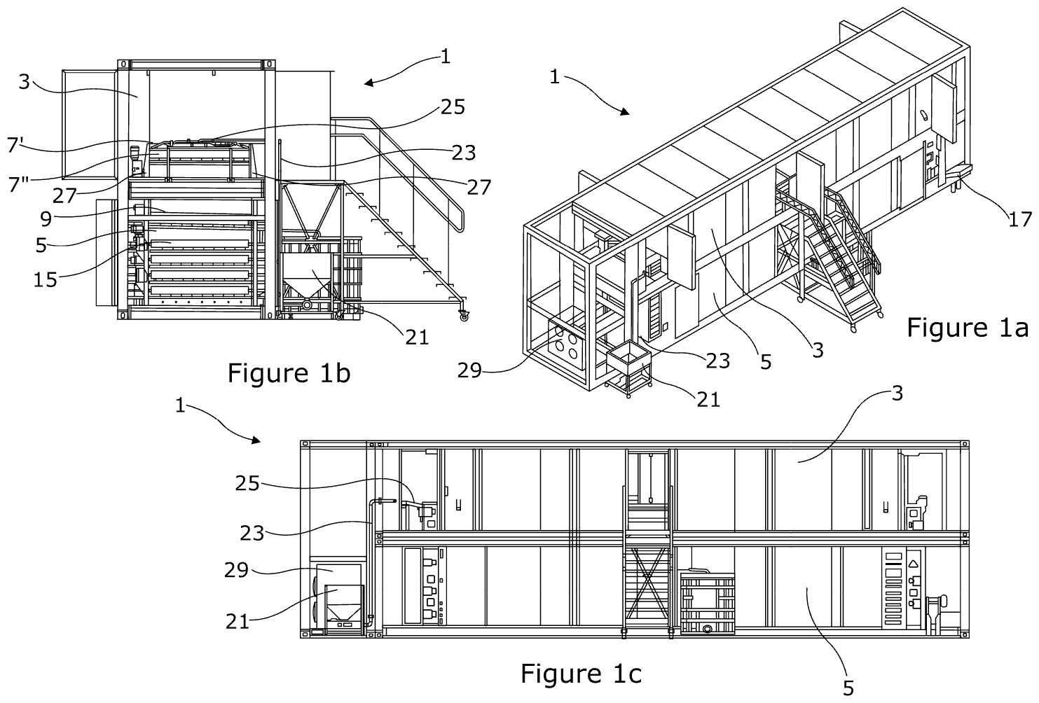

FIGS. 1a-c illustrate perspective, front and side views of a drying apparatus in accordance with an embodiment of the present invention;

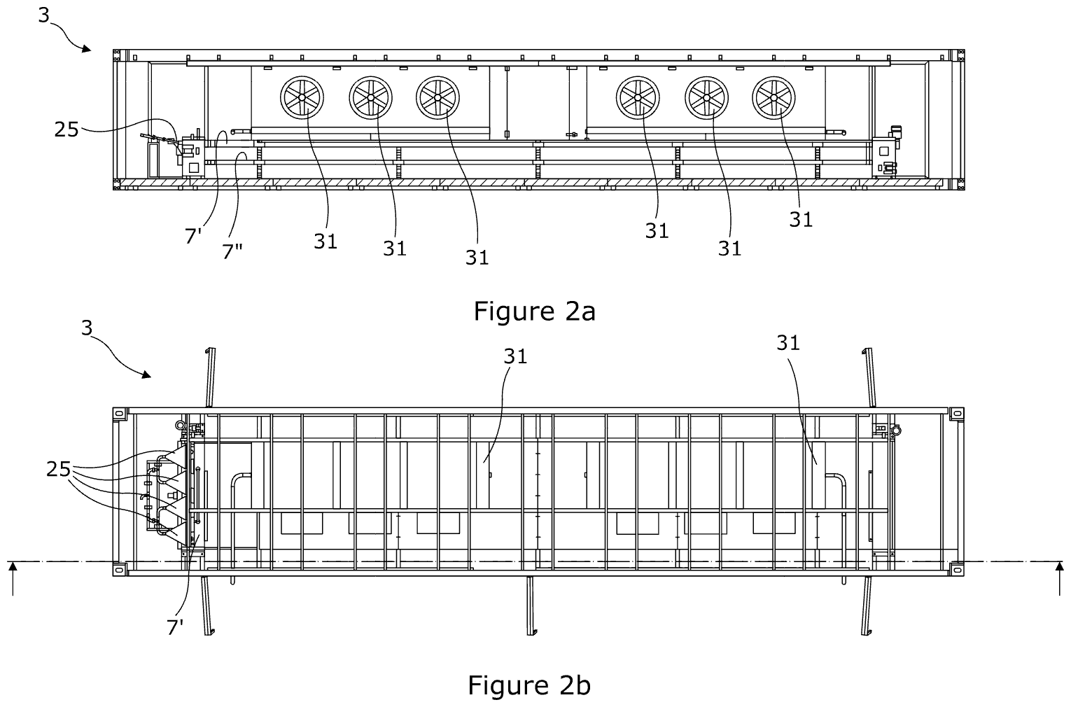

FIGS. 2a-b illustrate side and top-down views of a first, upper chamber of a drying apparatus in accordance with an embodiment of the present invention; and

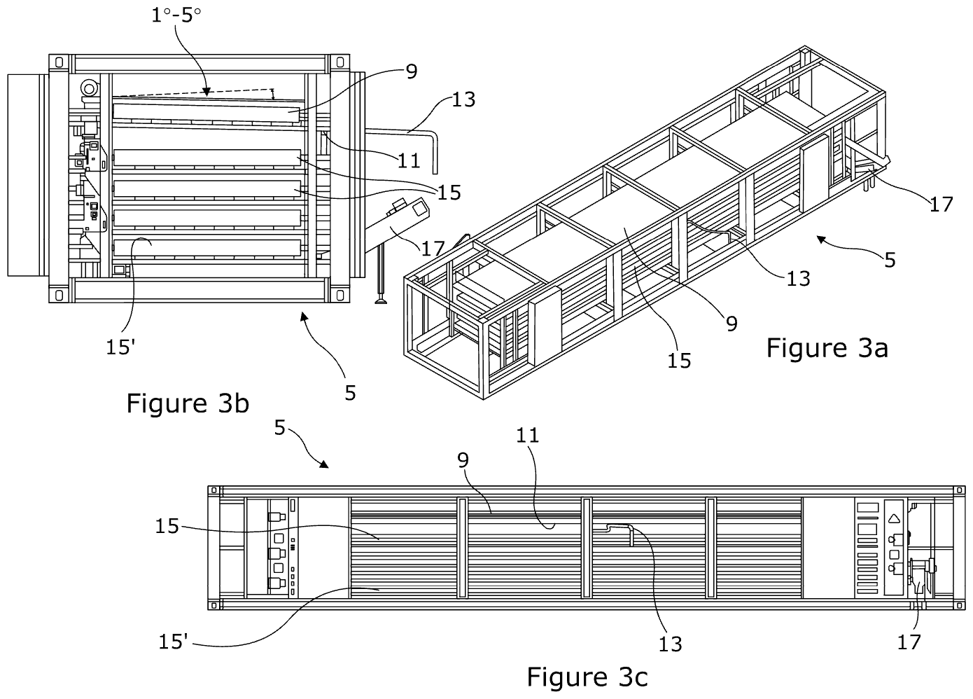

FIGS. 3a-c illustrate perspective, front and side views of a second, lower chamber of a drying apparatus in accordance with an embodiment of the present invention.

Referring now to the Figures, and FIGS. 1a-c illustrate perspective (FIG. 1a), front (FIG. 1b) and side (FIG. 1c) views of a drying apparatus 1. The apparatus 1 is provided primarily to be used to freeze, thaw and subsequently dry out alum sludge or alum sludge “cake”. The apparatus 1 comprises a first, upper chamber 3, shown in more detail in FIGS. 2a-b, and a second, lower chamber 5, shown in more detail in FIGS. 3a-c. The upper chamber 3 forms the freezing section of the apparatus 1 and within it is provided a first conveying means in the form of one or more conveyor belts 7, which move material deposited into the apparatus 1 through the freezing section. In the figures shown, two conveyor belts 7 are provided, which are disposed vertically spaced apart form one another. The belts 7 typically extend along the length of the interior of the upper chamber 3. In embodiments where two or more belts 7 are provided, such as depicted in FIG. 1b, the upper belt 7′ moves material therealong from a first end where it is deposited on to the belt 7′ to a second opposing end. The second, lower belt 7″ is arranged to convey material in the opposing direction and has a first end which extends beyond the edge of the second end of the upper belt 7′, allowing material reaching that second end of the upper belt 7′ to cascade down on to the lower belt 7″ at its first end. This can be repeated if further belts 7 are included in the freezing section. The conveyor speed in the freezing section is variable between 5 m/hour and 20 m/hour and the optimised speed and dwell time in the freezer is determined during commissioning to allow for the variable moisture content of the input material.

As the material reaches the second end of the final or lowermost belt 7″, it or at least the moisture contained therein has been frozen owing to the time spent in the freezing section, and it cascades from that end and through an aperture (not shown) in the floor of the upper chamber 3, which serves as the interface between it and the second, lower chamber 5. The lower chamber 5 comprises firstly a thawing section, which includes a second conveying means in the form of one or more conveyor belts 9. While only one belt 9 is illustrated in the figures as forming part of the thawing section, it will be appreciated that much like as described in the freezing section above, additional, lower belts 9 may be provided with their ends offset to permit cascading of the material from one belt to the next, as required. The belt 9 in the thawing section, while extending along the length of the interior of the lower chamber 5, is provided to be tilted or inclined at an angle perpendicular to the length or path of movement of the belt 9 and material thereon. The angle is provided to be between 1°-5° with respect to the horizontal plane of the belt 9 and is shown most clearly in FIG. 3b. By providing the conveyor belt 9 of the thawing section at such an angle, this permits liquid or supernatant thawing from the material to run-off the side of the belt 9 and away from the material. In order to prevent liquid or supernatant from simply seeping through the lower chamber 5, liquid collection means in the form of a trough or gutter 11, which allows the supernatant to be collected and subsequently removed through piping 13 where it may be reused as desired. The conveyor speed in the thawing section is controlled between 5 m/hour and 15 m/hour and is optimised during commissioning and is variable dependent on the initial moisture content of the input material.

Once the material has been thawed and the majority of the liquid or supernatant drained therefrom, the material cascades over the second end of the or the lowermost belt 9 from the thawing section, and on to third conveying means provided as part of the drying section, again within the lower chamber 5. The third conveying means comprises one or more conveyor belts 15, although in preferred embodiments, a plurality of vertically spaced apart belts 15 are provided, along which the material may be moved at a predetermined rate, cascading and descending from one belt 15 to the next, until it arrives at the second end of the final, lowermost belt 15′, where it exits the apparatus 1 through a further conveyor 17 in its preferred dry form for subsequent reuse, recycling or repurposing. The conveyor belt speed in the drying section is variable between 2 m/hour and 20 m/hour and is controlled during commissioning after measuring the output moisture content. The critical factor being that dried dust should be prevented.

The material may initially be stored and contained in a hopper 21, from which the material is drawn and moved, via a screw conveyor or auger conveyor 23 to the inlet 25. The inlet 25 includes a number of deposition devices which serve to deposit the material on to the first conveyor belt 7 evenly across its width, ensuring the material is distributed evenly across the belt 7. The apparatus 1 may be set up such that the designed input capacity may be moved through the freezing section. In order to prevent the material from spreading too far before it has frozen, the belt or belts 7 in the freezing section are provided with side walls 27 located along the lengths of each side of the belt(s).

As mentioned above, the first, upper chamber 3 acts as the freezing section and as such is required to be cooled to a desired temperature, generally in the range of between −5° C. to −20° C. This is achieved by providing refrigeration means associated with the apparatus 1. The refrigerated upper chamber set temperature is controlled during commissioning and is dependent on the resulting turbidity of the supernatant. The temperature is critical to prevent dendrite crystal formation entrapping sludge flocs. One or more refrigeration condensers 29 are provided with the apparatus 1 which are in fluid communication with one or more forced-air or air-cooling evaporators 31. A series of evaporators 31 are preferably provided located along the length of the upper chamber 3 in order to ensure the temperature to chilled evenly throughout. By adjusting the fan speed of the evaporators 31, the speed or flow rate of the chilled air circulating in the chamber 3 can be selected as desired, generally between 1 m/s and 10 m/s. The dwell time in the freezing section is variable between 1 hour and 4 hours and the conveyor belt 7 speed is set during commissioning and is dependent on the moisture content of the input material. In order to maintain the chilled temperature of the upper chamber 3 and increase energy efficiency, the walls, roof and flooring of the chamber 3 are insulated. As mentioned above, the refrigeration condenser(s) 29 is connected with the evaporators 31. The heat energy which is ultimately expelled by the condenser 29 is used to heat the lower chamber 5 to a desired temperature, which is generally between 10° C. to 30° C. above the ambient temperature of the apparatus' 1 surroundings, and preferably at around 20° C. above the ambient temperature. Thus, as the condenser 29 and evaporators 31 work together to cool the upper chamber 3, the heat drawn and subsequently expelled from the condenser 29 is directed into the lower chamber 5 by means of the heat pump effect: the upper chamber 3 acting as a heat source and the lower chamber 5 acting as a heat sink.

As the material is deposited through the inlet 25 on to the first belt 7, it is done so evenly at a thickness of between 10 mm to 40 mm. The set thickness is controlled and optimised during commissioning and is dependent on the initial moisture content of the material. The speed of the conveyor 7 may be varied in order to ensure the material remains within the freezing section for a predetermined period of time, before cascading down into the lower chamber 5 and to the thawing section. Typically, the material will be maintained in the freezing section and on the first conveyor 7 for a period of between 1 hour and 4 hours. Such a time period is dependent on the machine design capacity, speed of the first conveying means, air temperature of the freezing section in the first, upper chamber and the thickness of the material when deposited on to the first conveying means. When on the second conveyor belt or belts 9, the material is generally maintained in the thawing section for a period of between 30 minutes to 3 hours to ensure the required amount of liquid or supernatant has drained from the material. As the material cascades on to the third set of conveyors 15 in the drying section, the material is maintained in this section for an extended period of time to ensure the moisture content is reduced to the desired level. Typically, the material is maintained in the drying section for a period of between 10 to 18 hours. The dwell time is set to control the moisture content of the final drier product to prevent unwanted dried particles in the air stream. The apparatus 1 of the present invention therefore provides a continuous movement of the material throughout, from the freezing section through to the drying section and subsequently exiting through the outlet and further conveyor 17.

After processing and drying through the apparatus 1, the moisture content of the material upon exiting the apparatus 1 is about 50%. In most cases, alum sludge waste prior to any processing or drying will have a moisture content of around 97%, and after processing into an alum sludge “cake”, the moisture content is generally around 80%, and the material is unusable, resulting in it being sent to landfill. By reducing the moisture content to levels of 50% and below, the dried alum sludge can be readily recycled and reused, either as a building material, or after further processing by mixing and heating with a caustic soda solution, to produce aluminium oxide.

With the apparatus 1 described above, and example of the process which takes place to freeze, thaw and subsequently dry out a material, preferably alum sludge, is described in more detail below:

Alum sludge is pumped or extruded onto a continuous conveyor belt 7 inside a first, upper, insulated chamber 3 at the required optimised thickness. A refrigeration compressor is connected to forced air evaporators which serve to cool the air to the required temperature, in the range of −5° C. to −20° C. Cold air is circulated over the alum sludge at the required speed from the evaporators. The freezing rate and conditions may be changed by altering the thickness of the alum sludge on the belt 7, the temperature inside the chamber 3, the flow rate of the cold air within the chamber 3, and the speed at which the belt 7 is being moved. These are adapted to ensure that as the alum sludge freezes, planar ice crystals are formed, which separate from the sludge ensuring that no flocs are entrapped and when thawed, produce a clear supernatant. At the wrong conditions, dendrite ice crystals can grow, and these crystals entrap the flocs. The resultant supernatant is contaminated with flocs and cannot be recovered or recycled, while the alum sludge is also improperly processed/dried and cannot be reused.

Alum sludge is fed into a hopper 21 which feeds a pump/extruder/screw conveyor 23 to feed the sludge at high pressure to a depositing system 25 which spreads the sludge evenly across a moving conveyor 7. The sludge passes on the conveyor 7 through an insulated enclosure maintained at a low temperature, and is held in the cold chamber 3 on the upper conveyor belt 7′ and then cascades onto a second belt 7″ for a set duration until it has completely frozen. The sludge is then deposited onto an inclined conveyor 9 running at a controlled speed in a second, lower, warm chamber 5, which is warmed by the heat of rejection from the refrigeration condenser 29 (the heat pump effect). As the sludge thaws, the resulting supernatant flows from the inclined conveyor 9 into a trough 11 and the water is then passed through pipes 13 to be removed from the apparatus 1. The sludge is transferred from the thawing section onto a series of cascade conveyor belts 15 forming the drying section, in the same lower chamber 5. The sludge is dried over a number of hours to the required moisture content by the warm air passing from the refrigeration condenser 29.

The dried sludge is passed from the cascade conveyors 15 on to an outlet conveyor 17 to a finished collection point. The apparatus 1 and process provided by the present invention ensure that moisture can be removed from alum sludge at high energy efficiency, using approximately only 8.5% of the energy required than if drying by evaporating alone. The waste material can be fully recycled, reused and/or repurposed, either by using as a building material, or through a further process of mixing and heating with a caustic soda solution, to produce valuable aluminium oxide. The current cost of treatment and disposal of alum sludge is broadly similar to using the apparatus 1 and process of the present invention.

1. A drying apparatus, said apparatus including:
a first, upper chamber comprising a freezing section;
a second, lower chamber comprising a thawing section and a drying section;
the first, upper chamber further including an inlet, and first conveying means arranged to convey material through and within the freezing section;
the second lower chamber further including second conveying means arranged to convey material through and within the thawing section, and third conveying means arranged to convey material through and within the drying section, the third conveying means being disposed below the second conveying means, within the second, lower chamber;
the first, second and third conveying means each extending substantially along a length of the interior of the respective chambers; and
a first outlet in the drying section through which dried material exits the apparatus;
wherein the second conveying means is disposed below the first conveying means, and at least one aperture is provided located in the wall/interface between the first and second chambers, permitting material to be deposited from the first conveying means on to the second conveying means;
said first conveying means comprises first and at least second conveyor belt members, the second conveyor belt member disposed spaced apart from and vertically below the first conveyor belt member, the first and at least second conveyor belt members being arranged to convey material in opposing directions, in use; and
wherein first and at least second conveyor belt members are provided to form the third conveying means, the second conveyor belt member being disposed spaced apart from and vertically below the first conveyor belt member, the first and at least second conveyor belt members being arranged to convey material in opposing directions, in use.

2. (canceled)

3. (canceled)

4. (canceled)

5. A drying apparatus according to claim 1, wherein the first conveyor belt member is arranged to convey material from a first end to a second, opposing end thereof, and deposit said material on to a first end of the second conveyor belt member, disposed vertically below the first conveyor belt member, and wherein the first end of the second conveyor belt member extends beyond the second end of the first conveyor belt member, permitting material to cascade from the first conveyor belt member and down on to the second conveyor belt member, in use.

6. (canceled)

7. (canceled)

8. (canceled)

9. A drying apparatus according to claim 1, wherein said second conveying means is provided to be tilted/inclined at an angle perpendicular to the length or path of movement thereof.

10. A drying apparatus according to claim 9, wherein said angle is between 1°-5° with respect to the horizontal plane of the second conveying means.

11. A drying apparatus according to claim 9, wherein liquid collection means are provided associated with the second conveying means, along the length thereof, provided located at and along a lower side of the inclined second conveying means, arranged to collect liquid or supernatant thawing and running/draining from the material.

12. A drying apparatus according to claim 1, wherein said first conveying means further includes side walls provided associated therewith, along the length thereof, provided to maintain the material on the first conveying means as it is moved through the freezing section, in use.

13. A drying apparatus according to claim 1, wherein refrigeration means are provided to cool the temperature of the first, upper chamber and thus the freezing section.

14. (canceled)

15. (canceled)

16. (canceled)

17. A drying apparatus according to claim 1, wherein one or more evaporator means are located with the first, upper chamber, provided to cool the internal temperature of the first, upper chamber to a required temperature.

18. A drying apparatus according to claim 17, wherein the apparatus further includes condenser means provided therewith, in communication with the evaporator means, and wherein heat expelled from said condenser means is arranged to be directed into the second, lower chamber, heating the same to a desired temperature.

19. (canceled)

20. A drying apparatus according to claim 1, wherein the apparatus is arranged to provide continuous movement of material therein from the freezing section through to the drying section and subsequently exiting through the outlet, in use.

21. A drying apparatus according to claim 1, wherein the apparatus further includes containing means in which material to be dried and processed is located and stored, and further conveying means are provided to move the material from the containing means to the inlet.

22. A drying apparatus according to claim 1, wherein the inlet includes depositing means arranged to distribute material evenly across the surface of the first conveying means at a first end thereof, in use.

23. A process for drying a material using an apparatus as defined in claim 1, said process including the steps of:
depositing said material on to first conveying means located in the freezing section of the first, upper chamber through the inlet thereof;
moving said material through the freezing section on said first conveying means at a predetermined rate until the material and moisture within the material has frozen;
depositing the material from the freezing section on to second conveying means located in the thawing section of the second, lower chamber;
moving said material through the thawing section on said second conveying means at a predetermined rate until the material thaws and liquid drains therefrom;
depositing the material from the thawing section on to third conveying means located in the drying section of the second, lower chamber;
moving said material through the drying section on said third conveying means at a predetermined rate until the moisture content of the material is reduced to a desired level; and
removing the dried material from the drying section through an outlet provided therein.

24. A process according to claim 23, wherein said material being dried is alum sludge.

25. A process according to claim 23, wherein the first conveying means is arranged to move at a speed of between 5 m/hour and 20 m/hour; the second conveying means is arranged to move at a speed of between 5 m/hour and 15 m/hour; and the third conveying means is arranged to move at a speed of between 2 m/hour and 20 m/hour.

26. A process according to claim 23, wherein the material is deposited on to the first conveying means at an average thickness of between 10 mm to 40 mm.

27. (canceled)

28. A process according to claim 23, wherein evaporator means impart a flow of cooled air into the first, upper chamber, the speed of said flow of air being between 1 m/s and 10 m/s.

29. A process according to claim 23, wherein the second, lower chamber is maintained at a temperature of between 10° C. to 30° C. above the ambient temperature of the location in which the apparatus is located.

30. A process according to claim 23, wherein the material is maintained in the freezing section and on the first conveying means for a period of between 1 hour and 4 hours; the second conveying means moves at a rate to maintain the material in the thawing section for a period of between 30 minutes to 3 hours; and the third conveying means moves at a rate to maintain the material in the drying section for a period of between 10 to 18 hours.

31. (canceled)

32. A process according to claim 23, wherein the moisture content of the material upon exiting the apparatus is no more than about 50%.
